(19) United States
(12) Patent Application Publication
(10) Pub. No.: US 2005/0062843 A1
(43) Pub. Date: Mar. 24, 2005

(54) Client-side audio mixing for conferencing

(76) Inventors: Richard D. Bowers, Roseville, CA (US); Kevin Hutler, Foresthill, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/667,873

(22) Filed: Sep. 22, 2003

(51) Int. Cl. H04N 7/14

(52) U.S. Cl. 348/14.08; 348/14.13

(57) ABSTRACT

A videoconferencing system has multiple conferencing stations. Each conferencing station has audio output apparatus, audio and video compression modules for receiving video from the video source and audio from the audio capture circuitry and for transmitting compressed audio and video through a network. Each station compresses audio from its audio capture circuitry and, when this audio has amplitude above a threshold, transmits the compressed audio to a server. The server combines compressed audio streams into a single composite stream without decompressing and mixing the audio streams, and broadcasts this potentially multichannel stream to each conferencing station. Each conferencing station also has an audio mixer module for receiving the composite compressed audio stream through the network interface apparatus from the server, for decompressing and mixing channels of interest in the audio streams, and for providing audio to the audio output apparatus.

### FIELD OF THE DISCLOSURE

The present document relates to the field Internet-Protocol (IP)-based audio and/or video conferencing. In particular, it relates to apparatus and methods for mixing multiple streams of audio during realtime audio and/or video conferencing.

### BACKGROUND

Internet-protocol (IP)-based audio and video conferencing has become increasingly popular. In these conferencing applications, there are typically multiple conferencing stations, as illustrated in FIG. 1. When three or more conferencing stations are linked for bidirectional conferencing, each conferencing station 102 typically has a processor 104, memory 106, and a network interface 108. There are also a video camera and microphone 110, audio output device 112, and a display system 114. Audio and video are typically captured by video camera and microphone 110, compressed in processor 104 and memory 106, operating under control of software in memory 106, and transmitted over network interface 108 and computer network 118 to a server 120. Computer network 118 typically uses the User Datagram Protocol (UDP), although some embodiments may use the TCP protocol. The UDP or TCP protocols typically operate over an Internet Protocol (IP) IP layer. Audio transmitted with either UDP or TCP over an IP layer is known as voice-over-IP. The computer network often is the Internet, although other network technologies can suffice.

In a typical conferencing system, server 120 has a processor 122 which receives compressed audio and video streams through network interface 124, operating under control of software in memory 126. The software includes an audio mixer 128 module, for decompressing and combining separate compressed audio streams, such as audio streams 129 and 131, received from each conferencing station 102, 130, 132 engaged in a conference. A mixed audio stream 140 is transmitted by server 120 through network interface 124 onto network 118 to each conferencing station 102, 130, 132, where it is received by network interface 108, decompressed by processor 104 operating under control of software in memory 106, and reconstructed as audio by audio output interface 112.

Typically, the server's mixer module 128 must construct and transmit separate audio streams for each conferencing station 102, 130, 132. This is done such that each station 102 can receive a mixed audio stream that lacks contribution from its own microphone. Mixing multiple audio streams can be burdensome to the server if many streams must be mixed.

Similarly, server 120 receives the compressed video streams from each conferencing station 102, 130, 132, through network interface 124. A video selector 134 module selects an active video stream for retransmission to each conferencing station 102, 130, 132, where the video stream is received through network interface 108, decompressed by processor 104 operating under control of software in memory 106, and presented on video display 114.

Variations on the video conferencing system of FIG. 1 are known, for example video selector 134 module may combine multiple video streams into the active video stream for retransmission using picture-in-picture techniques.

There may be substantial transmission delay between conferencing stations 102, 130, 132 and the server 120. There may also be delay in compressing and decompressing the audio streams in processor 104 of the conferencing station, and there may be delay involved in receiving, decompressing, mixing, recompressing, and transmitting audio at the server 120. This delay can cause noticeable echo in reconstructed audio that is difficult to cancel and can be disturbing to a user. Further, two network delays are encountered by audio streams; this can be noticeable and inconvenient for users.

Systems have been built that solve the problem of delayed echo by creating separate mixed audio streams 140, 141 at the server for transmission to each conferencing station 102, 130, 132, where each mixed audio stream has audio from all conferencing stations transmitting audio except for audio received from the conferencing station on which that stream is intended to be reconstructed.

Videoconferencing systems of this type may also incorporate a voice activity detector, or squelch, module in memory 106 for determining when the microphone of camera and microphone 110 of each conferencing station is receiving audio, and for suppressing transmission of audio to the server 120 when no audio is being received.

### SUMMARY

Each conference station of a conferencing system compresses its audio and sends its compressed audio stream to a server. The server combines the compressed audio streams it receives into a composite stream comprising multiple, separate, audio streams.

The system distributes the composite stream over a network to each conference station. Each station decompresses and mixes the audio streams of interest to it prior to reconstructing analog audio and driving speakers. The mixing is done such that audio that a first station transmits is not included in the mixed audio for driving speakers at the first station.

### BRIEF DESCRIPTION OF THE FIGURES

FIG. 1 is an abbreviated block diagram of a typical IP-based video conferencing system as known in the art.

FIG. 2 is an abbreviated block diagram of an IP-based video conferencing system having local audio mixing.

FIG. 3 is an exemplary illustration of blocks present in an audio stream as transmitted from a conferencing station to the server.

FIG. 4 is an exemplary illustration of blocks present in the composite audio stream as transmitted from the server to the conferencing stations.

FIG. 5 is an exemplary illustration of data flow in the conferencing system.

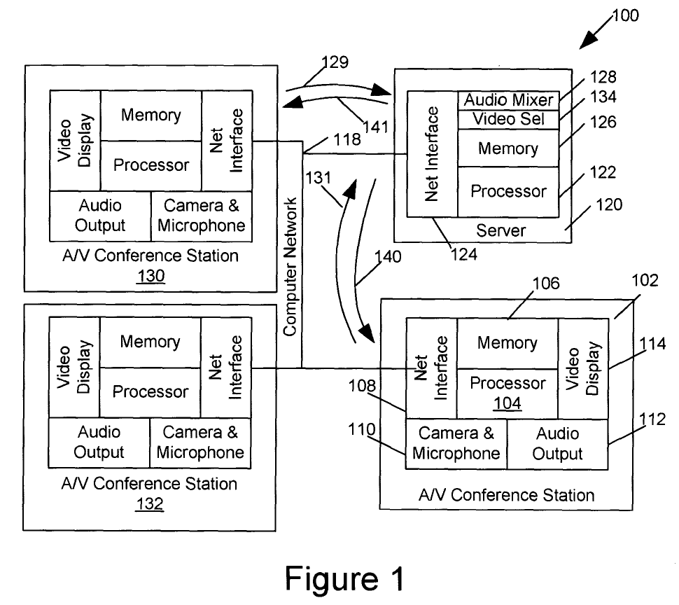

### DETAILED DESCRIPTION OF THE EMBODIMENTS

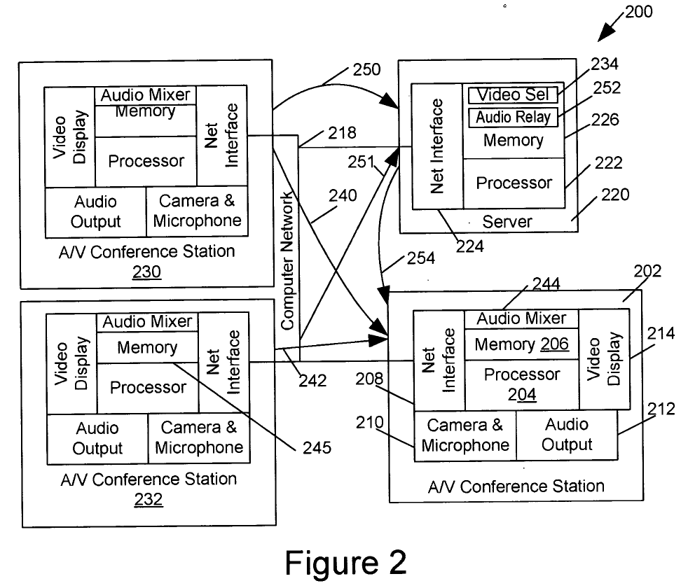

A novel videoconferencing system 200 is illustrated in FIG. 2, for use with multiple conferencing stations 202, 230, 232 linked by a network for conferencing.

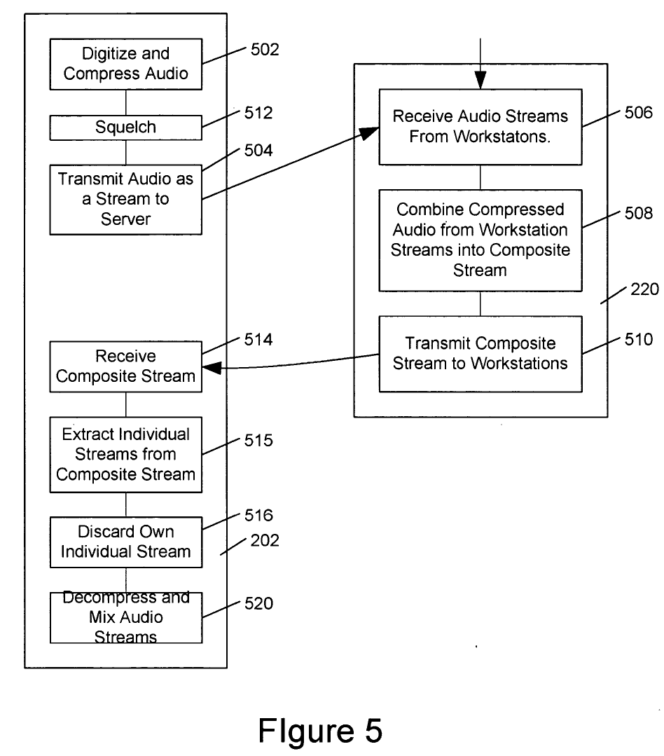

Each conferencing station 202, 230, 232 of this system has a processor 204, memory 206, and a network interface 208. There are also a video camera and microphone 210, audio output device 212, and a display system 214. With reference also to FIG. 5, audio and video are captured by video camera and microphone 210, and digitized 502 in video and audio capture circuitry, compressed in processor 204 and memory 206, operating under control of software in memory 206, and transmitted 504 over network interface 208 and computer network 218.

In another embodiment, processor 204 of videoconference station 202 runs programs under an operating system such as Microsoft Windows. In this embodiment display memory of a selected videoconference station is read to obtain images; these images are then compressed and transmitted as a compressed video stream. These images may include video images from a camera in a window.

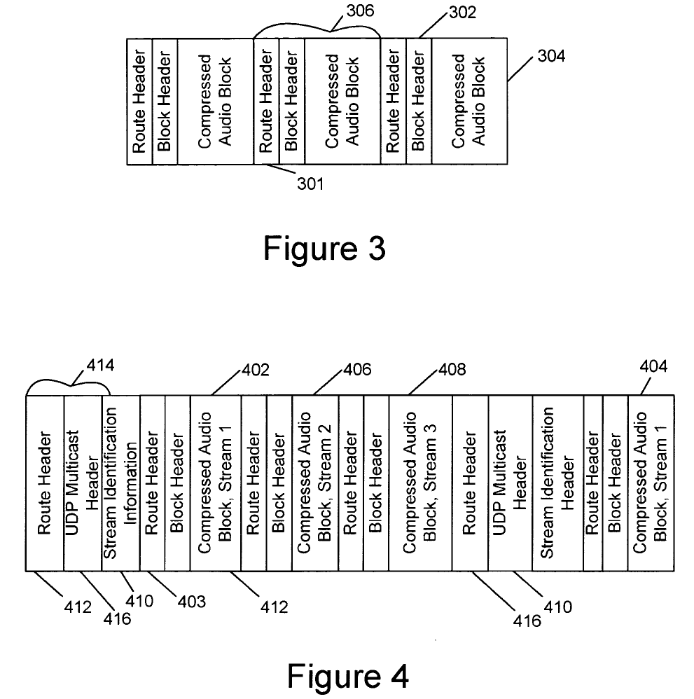

Video is transmitted to a server 220. Audio is transmitted as compressed audio streams 250, 251 to the server 220. An individual stream is illustrated in FIG. 3. These streams 250, 251 are received 506 as a sequence of packets 306, each packet having a routing header 301. Each packet may include part or all of an audio compression block, where each compression block has a block header 302 and a body 304 of compressed audio data, at the server's network interface 224. Block header 302 includes identification of the transmitting videoconference station 202, and may include identification of a particular compression algorithm used by videoconference station 202.

These audio streams 250, 251, are combined 508 into a composite, potentially multichannel, stream and retransmitted 254, 510 by an audio relay module 252 to the conferencing stations 202, 230, 232, engaged in the conference. The composite stream is illustrated in FIG. 4. The composite stream is a multichannel stream at times when more than one stream 250, 251 is received from conferencing stations 202, 230, 232. Combining 510 the streams into the composite stream is done without decompressing and mixing audio of the streams 250, 251 received by the server 220 from the individual conferencing stations. As packets 306 of each stream are received by the audio relay module 252, they are sorted into correct order, then the routing headers 301 of the received packets 306 are stripped off. Packet routing headers 301 are used for routing packets through the network. Routing headers 301 and 412 (FIG. 4) includes headers of multiple formats distributed at various points in the data stream, as required for routing data through the network according to potentially multiple layers of network protocol; for example in an embodiment the stream includes as routing headers 301 and 412 UDP headers 416, IP headers, and Ethernet physical-layer headers. Some layers of routing headers, such as physical-layer headers, are inserted, modified, or deleted as data transits the network.

The block headers 302 and compressed audio data are extracted from packet bodies 306 by the audio relay module 252. Without decompression or recompression, the compressed audio data is placed into a packet body 402, with associated block headers 403, in an appropriate position in the transmitted composite stream. In the composite stream, packet bodies 402, 404 containing compressed audio data from a first received audio stream may be interleaved with packet bodies 406, 408, from additional received audio streams. Periodically, an upper level protocol route header such as an UDP/Multicast IP header 416 and a stream identification packet 410 containing stream identification information is injected into the composite stream; this stream identification information can be used to identify packet bodies 402, 404 associated with each separate received stream such that the compressed audio data of these streams can be extracted and reassembled as separate compressed audio streams. The stream identification information is also usable to identify the conferencing station which originated each compressed audio stream relayed as a component of the composite stream.

In an alternative embodiment, the stream identification packet 410 includes a count of the audio streams interleaved in the transmitted composite stream, while identification of the conferencing station originating each stream is included in block headers 403. Packet routing headers 412, 416 are also added as the stream is transmitted to direct the routing of packets 414 of the composite stream to the conferencing stations.

In this embodiment, each conference station 202 incorporates a voice activity detector, or squelch 512, module in memory 206 that determines when the microphone of camera and microphone 210 is receiving audio. The voice activity detector suppresses transmission of that station's audio to the server 220 when that station's audio is quiet. That station's audio is quiet when no audio above a threshold is being received by the microphone, indicating that no user is speaking at that station. Suppression of quiet audio streams reduces the number of audio streams that must be relayed as part of the composite stream through the server 220, and reduces workload of each conference station 202, 230, 232 by reducing the number of audio streams that must be decompressed and mixed at those stations. The count of audio streams in the identification packet 410 of the composite stream changes as audio streams are suppressed and de-suppressed. It is expected that during typical conferences, only one or a few unsuppressed audio streams will be transmitted to the server, and retransmitted in the composite stream, during most of the conferences' existence.

In an alternative embodiment, each conferencing station 202, 230, 232 monitors the volume of audio being transmitted by that station, and includes, at frequent intervals, in its compressed audio stream 250, 251 an uncompressed volume indicator. In this embodiment, in order to limit network congestion and workload at each receiving conferencing station 202,230, 232; the audio relay module 252 limits the audio streams 254 in the composite stream retransmitted to conference stations to a predetermined maximum number of retransmitted audio streams greater than one. The retransmitted audio streams 254 are selected according to a priority scheme from those streams 250, 251 received from the conference stations. The audio streams are selected for retransmission first according to a predetermined conference station priority classification, such that conference moderators will always be heard when they are generating audio above the threshold, and second according to those received audio streams 250, 251 having the loudest volume indicators. It is expected that alternative priority schemes for determining the streams incorporated into the composite stream and retransmitted by the server are possible.

Server 220 has a processor 222 which receives compressed video streams through network interface 224, operating under control of software in memory 226. A video selector 234 module selects an active video stream for retransmission to each conferencing station 202, 230, 232, where the video stream is received through network interface 208, decompressed by processor 204 operating under control of software in memory 206, and presented on video display 214.

Computer readable code in memory of each conferencing station 202 includes an audio mixer 244 module. The audio mixer module receives 514 the composite stream from the server, extracts 515 individual audio streams of the composite stream, and, if present, discards 516 any audio stream originating from the same conferencing station 202 from the composite stream. The audio mixer module, executing on processor 204, then decompresses 520 any remaining audio streams of the composite audio stream and mixes them into mixed audio. The mixed audio is then reconstructed as audio by audio output interface 212. Audio output interface 212 may be incorporated in a sound card as known in the art of computer systems.

In an alternative embodiment, audio mixer 244 module prepares a first mixed audio signal as heretofore described. In this embodiment, audio mixer module 244 also prepares a second mixed audio signal that includes any audio stream originating from the same conferencing station 202. This second mixed audio signal is provided at an output connector of conferencing station 202 so that external recording devices can record the conference.

Video selector 234 module may combine multiple video streams into the active video stream for retransmission using picture-in-picture techniques.

In an alternative embodiment, the functions heretofore described in reference to the server 220 are performed by one of the videoconferencing stations 232.

A computer program product is any machine-readable media, such as an EPROM, ROM, RAM, DRAM, disk memory, or tape, having recorded on it computer readable code that, when read by and executed on a computer, instructs that computer to perform a particular function or sequence of functions. The computer readable code of a program product may be part or all of a program, such as a module for mixing audio streams. A computer system having memory, the memory containing an audio mixing module conferencing according to the heretofore described method is a computer program product.

While the forgoing has been particularly shown and described with reference to particular embodiments thereof, it will be understood by those skilled in the art that various other changes in the form and details may be made without departing from the spirit and hereof. It is to be understood that various changes may be made in adapting the description to different embodiments without departing from the broader concepts disclosed herein and comprehended by the claims that follow.

1. A conferencing system comprising:
a server for relaying compressed audio streams received by the server from conferencing stations to conferencing stations of the system; and
a plurality of conferencing stations, where each conferencing station comprises:
a processor,
a microphone coupled through audio capture circuitry to the processor,
a network interface apparatus coupled to the processor,
audio output apparatus,
memory coupled to the processor, the memory having stored therein program modules comprising:
an audio compression module for receiving audio from the audio capture circuitry, compressing the received audio into compressed audio and for transmitting the compressed audio through the network interface apparatus as a compressed audio stream, and
an audio mixer module for receiving at least one compressed audio stream from a conferencing station as relayed by the server through the network interface apparatus, for decompressing and mixing the at least one compressed audio stream into mixed audio, and for providing the mixed audio to the audio output apparatus.

2 The conferencing system of claim 1, wherein the audio mixer module of each station receives, decompresses, and mixes a plurality of compressed audio streams relayed through the server.

3. The conferencing system of claim 2, wherein at least one said conferencing station further comprises:
a video source,
a compression module in the memory for receiving video from the video source, for compressing the video into a first video stream, and for transmitting the first video stream to the server,
a video decompression module for receiving a second video stream, decompressing the second video stream into images, and
a display subsystem for presenting the images to a user.

4. The conferencing system of claim 2, wherein the server comprises a relay module for receiving audio streams from the conferencing stations, for combining the received audio streams into a composite audio stream, and for retransmitting the composite audio stream to the conferencing stations, wherein the composite audio stream is created without decompressing the received audio streams.

5. The conferencing system of claim 4, wherein the relay module selects a maximum number of received audio streams for retransmission according to a priority scheme incorporating a predetermined conferencing station priority.

6. The conferencing system of claim 4, wherein a first said conferencing station receives the composite audio stream, decompresses selected audio streams from individual compressed audio streams of the composite audio stream, the selected audio streams determined such that audio from the first said conferencing station relayed through the server is discarded by the first conferencing station.

7. The conferencing system of claim 2, wherein the server comprises a relay module for receiving audio streams from the conferencing stations, for combining the received audio streams into a composite audio stream, and for retransmitting the composite audio stream to the conferencing stations, wherein the composite audio stream is created by interleaving compressed audio from packets of the received audio streams.

8. A conferencing station comprising
a processor,
a microphone coupled through audio capture circuitry to the processor,
a network interface apparatus coupled to the processor,
audio output apparatus,
memory coupled to the processor, the memory having recorded therein program modules comprising:
an audio compression module audio from the audio capture circuitry and for transmitting compressed audio through the network interface apparatus; and
an audio mixer module for receiving compressed audio streams through the network interface apparatus from a plurality of conferencing stations, for decompressing and mixing the audio streams into mixed audio, and for providing the mixed audio to the audio output apparatus.

9. The conferencing station of claim 8, wherein the audio mixer module receives the compressed audio streams as a composite audio stream from the server, and wherein the conferencing station decompresses selected audio streams, the selected audio streams being selected from compressed audio streams of the composite audio stream selected such that audio from the first said conferencing station relayed through the server is not decompressed by the first conferencing station.

10. The conferencing station of claim 8, further comprising a video source, and wherein the program modules further comprise a video compression module for compressing video from the video source and for transmitting compressed video through the network interface.

11. A computer software product comprising a machine readable media having recorded thereon machine readable code for:
an audio compression modules for receiving audio from audio capture circuitry, compressing the audio, and for transmitting compressed audio through network interface apparatus to a server; and
an audio mixer module for receiving a composite compressed audio streams through the network interface apparatus from a server, for selecting audio streams from the composite audio stream, for decompressing and mixing the selected audio streams, and for providing audio to the audio output apparatus.

12. A method of conferencing comprising the steps of:
at each of a plurality of conferencing stations, compressing audio into compressed audio, and transmitting the compressed audio as a compressed audio stream to a server;
at the server, combining the compressed audio streams from a plurality of conferencing stations into a composite stream;
distributing the composite stream over a network to the plurality of conferencing stations;
at at least one conferencing station, decompressing and mixing a plurality of audio streams of the composite stream into a reconstructed audio stream; and
driving speakers with the reconstructed audio stream.

13. A method of generating a composite compressed audio stream for use in a conferencing system comprising the steps of:
receiving a plurality of compressed incoming audio streams at a server, where each compressed audio stream comprises a sequence of blocks of compressed audio data;
copying blocks of compressed audio data from a plurality of the compressed incoming audio streams into the composite audio stream;
inserting routing information into the composite audio stream; and
inserting identification information into the composite audio stream, the identification information comprising a count of audio streams present in the composite audio stream.

14. The method of claim 13, wherein blocks of compressed audio data are selected for copying into the composite audio stream according to a priority scheme such that compressed audio blocks of incoming audio streams associated with conference moderators have priority for copying into the composite audio stream over compressed audio blocks of other incoming audio streams.
